(19) United States
(12) Patent Application Publication
(10) Pub. No.: US 2026/0118280 A1
(43) Pub. Date: Apr. 30, 2026

(54) COMBINED SEGMENTATION AND COMPUTER VISION MACHINE LEARNING MODELS FOR ROOF DAMAGE DETECTION

(71) Applicant: State Farm Mutual Automobile Insurance Company, Bloomington, IL (US)

(72) Inventor: Jacob Braun, Oviedo, FL (US)

(21) Appl. No.: 18/933,033

(22) Filed: Oct. 31, 2024

(51) Int. Cl. G01N 21/88; G06T 7/10; G06T 11/60

(52) U.S. Cl. CPC G01N 21/8851; G06T 7/10; G06T 11/60; G06T 2207/20084

(57) ABSTRACT

Techniques are described herein for using combinations of segmentation and computer vision machine learning (ML) models to detect and assess roof damage based on image data. In various examples, a damage assessment system may receive one or more images of a roof surface. The damage assessment system may use a segmentation model to segment the roof images and determine segment attributes. A segmentation mask based on the output of the segmentation model may be combined with the image data and provided as a multimodal input to a computer vision ML model to analyze and assess the roof surface for potential damage. In some examples, the computer vision model may include a recurrent neural network (RNN) trained to process multiple images of the same roof surface. Various outputs from the computer vision model may include damage determinations, causes, severities, and/or damage fraud detection.

### TECHNICAL FIELD

The present disclosure relates to techniques for training and using ML models focused on roof damage detection and assessment. In particular, the present disclosure relates to using a combination of segmentation models and computer vision models to detect and assess roof damage based on input images.

### BACKGROUND

Inspection and damage assessment of building roofs may be critical processes in various industries, such as insurance and construction industries. Generally, the tasks of roof inspection and damage assessment have relied heavily on manual techniques performed by human inspectors and estimators. While experienced professionals provide certain insights, these traditional approaches also may come with various challenges and limitations. For example, manual inspection and damage estimation may require considerable time and on-site resources. An estimator or inspector typically may need physical access to the roof to identify damage and determine whether replacement is necessary. This process can be time-consuming, especially when dealing with multiple properties or large-scale assessments following weather events and natural disasters. Manual roof inspections also may expose human inspectors to potentially dangerous conditions, including the risk of falling while working on elevated surfaces. This danger may be amplified in adverse weather conditions such as wind or rain, which are common in many regions. The safety concerns associated with roof inspections not only put workers at risk, but also may limit the conditions under which roof inspections or estimations can be safely conducted.

Additionally, the accuracy and consistency of manual roof inspections can be complicated or compromised by various factors and real-world challenges. Different roofing materials, roof pitch, lighting conditions, and weather conditions can make manual roof inspection and damage estimation extremely difficult, which can lead to subjective assessments that may not provide a repeatable or consistent approach. The subjective nature of human assessments may introduce variability in inspectors and damage evaluations. Two estimators examining the same roof surface may arrive at different conclusions regarding the existence or severity of the roof damage, or the necessity for repairs or replacement. Thus, traditional techniques may result in inconsistent and potentially unreliable results across different inspections or estimators. This lack of standardization can lead to disputes between property owners and insurance companies, as well as inconsistencies in claim processing and settlement.

The problems of manual roof inspection and damage estimation can be exacerbated when dealing with large-scale events, such as hurricanes, tornados, or severe storms that may large populations across a wide area. The need for rapid assessment in these situations often strains available human resources, potentially leading to delays in claims processing and property restoration. Given these challenges, there is a clear need for improved techniques that provide for efficient, accurate, and safer methods of roof inspection and damage estimation. Improvements in these industries could potentially streamline property inspections, insurance claim processing, and the initiation, execution, and evaluation of roof construction and repair projects. Such improvements also may improve the accuracy and consistency of damage evaluations and may significantly reduce the risks associated with manual roof inspections.

The example systems and methods described herein may be directed toward mitigating or overcoming one or more of the deficiencies described above.

### SUMMARY

As discussed above, existing approaches for roof inspection, damage assessment and estimation, and the like, may rely on manual inspection performed by human inspectors, which can be time-consuming, dangerous, and prone to inaccuracies. Additionally, manual approaches also may lead to subjective and/or inconsistent assessments, as well as potential safety risks for inspectors, and challenges in efficiently performing large numbers of inspections, particularly following widespread weather events, natural disasters, etc. These limitations can lead to delays in claims processing, inaccurate evaluations, and inefficiencies in the insurance and construction industries when dealing with roof damage assessments.

In order to address the limitations of existing techniques, various techniques are described herein (e.g., methods, computing devices and systems, non-transitory computer-readable media storing instructions, etc.) for using combinations of machine learning (ML) models, including segmentation models and computer vision models in conjunction to detect and assess roof damage. In some examples, a damage assessment system may receive one or more images of a roof surface, and provide the roof images to a segmentation model to segment the roof images and determine segment attributes. A segmentation mask may be generated based on the output of the segmentation model, which may be combined with the image data (and/or additional roof attribute data) to determine a multimodal input for the computer vision model. The computer vision model, which may be implemented using a convolutional neural network (CNN), recurrent neural network (RNN), graph neural network (GNN)), etc., may analyze and assess the damaged roof surface based on the multimodal input. In various examples, the computer vision model may be trained to output various damage determinations and/or probabilities, causes, severities, instances of potential damage fraud, and the like.

In some examples, the damage assessment system may be configured to generate and provide a multimodal input to the computer vision model. That is, the input to the computer vision model may include image input data (e.g., one or more images of a damaged roof) along with segmentation data determined using the segmentation model. For example, a segmentation mask determined by the segmentation model may include various segment attributes corresponding to different portions of the image. In some cases, a segmentation mask may include one or more per-pixel segment attributes, such as a segment identifier that identifies (for each pixel or other region in the image) the segment associated with that pixel. Additionally or alternatively, a segmentation mask may include other segment attributes associated with each pixel in the image, such as the segment shape, segment size, segment color, segment depth, and/or other relevant segment attributes.

In some cases, the damage assessment system may apply the segmentation mask determined by the segmentation model to the corresponding image data, to generate a multichannel image representation. For instance, the multichannel representation may include the visual image data (e.g., RGB data) for each pixel, supplemented with additional data channels containing the segmentation data corresponding to the pixel. For instance, the segmentation channel(s) within the multichannel image representation may store labels identifying the segment identifier, segment size, segment shape, segment color, etc., for each image pixel. Additionally, while multichannel image representations are described in this example as per-pixel data, in other examples, the segmentation mask data need not be applied to the image at the pixel level, but could be applied to large regions/elements in the image.

As described herein, the additional rich segmentation data provided by the segmentation model, when combined with the raw image data, may enable the downstream computer vision model to perform more nuanced and accurate damage detection and assessment. For example, a computer vision model may receive as input a multichannel roof representation that incorporates both the visual data as well as the segment structure and/or characteristics of the roof surface, allowing the computer vision model to learn simultaneously based on both modalities (e.g., the raw image data and segment structure/attribute data). Thus, the computer vision models implemented using these techniques, such as CNNs, RNNs, GNNs, etc., can more accurately analyze roof image data to determine and assess potential roof damage.

Further, incorporating and providing the segmentation data to the computer vision model may provide particular advantages when the image data includes lower resolution and/or partially occluded data. For instance, images captured from farther distances, such as by drones or low-altitude plane flyovers may have lower resolutions and more obstructing objects (e.g., tree branches, chimneys, etc.) than images taken using handheld cameras by human inspectors. As a result, these longer-range or lower-resolution images may be unsuitable using existing approaches. However, by determining and applying segmentation masks to the image data using the techniques herein, and providing the multimodal data (e.g., a multichannel image representation using segmentation data) to a computer vision model, the computer vision model may perform more accurate damage detection and assessment even when using longer-range and/or lower-resolution data (e.g., drone images, low-altitude plane images, etc.). Thus, techniques herein can significantly improve efficiency for evaluating multiple properties and/or large-scale roof damage assessments, such as following large weather events or natural disasters.

In addition to incorporating segmentation data as an input to the computer vision model (and/or as an alternative to incorporating segmentation data), the damage assessment system also may be configured to provide additional inputs such as roof attributes to the computer vision model. For instance, in addition to the raw image data and/or segmentation data, the computer vision model may be trained and configured to receive input data including the roof pitch, material type, and/or age of the roof surface. As described above for segmentation data, in some examples, additional roof attributes can be incorporated into a multichannel representation of the roof surface, including separate dedicated per-pixel (or per-region) data channels storing image data, segmentation data, and these additional roof attributes. As an example, a multichannel representation of a roof may include, for each pixel (or other region) on the roof surface, data channels representing the visual image data (e.g., RGB data) for that pixel, additional data channels representing segmentation data for that pixel, and further additional data channels representing roof attributes for that pixel, such as roof pitch, roof material, roof age, etc.

As noted above for segmentation data, incorporating additional roof attributes into a multichannel representation that is provided as input to the computer vision model may improve the efficiency and accuracy the damage detections and assessments performed by the model. For instance, combining roof attributes such as roof material, pitch, age, etc., along with the raw image data and/or segmentation data in a multichannel representation, may allow the computer vision model (e.g., a CNN, RNN, GNN, etc.) to learn simultaneously based on the combination of modalities. The resulting computer vision model may be trained to perform more nuanced and accurate damage detections and assessments based on multimodal input data. Additionally, incorporating roof surface attributes such as pitch, material, and age into a multichannel representation may provide significant advantages for non-uniform roof surfaces, in which different portions of a roof may have different pitches, different materials, and/or different ages, etc.

As described above, additional data beyond the raw image data, such as segmentation data and/or roof attributes, may be provided as input to the computer vision model. In such examples, the inputs to the computer vision model may be referred to as multimodal inputs (e.g., image data plus one or more additional modalities/types of input data). In some instances, as described above, the multimodal inputs may be provided to the computer vision model as a multichannel image representation in which the additional input data is encoded and incorporated as additional per-pixel (or per-region) data channels into the image representation. However, in other instances, the computer vision model may be configured to receive the additional segmentation data, roof attribute data, and/or any other additional input data as feature vectors separate from the raw image data. For instance, a feature vector representing the segmentation data, a feature vector representing one or more roof attributes, etc., may be concatenated to the image data and provided as input to the computer vision model.

Other modalities/types of input data that may be provided as input to the computer vision model can include, for example, data describing a recent damage event that has occurred in the geographic region where the image data was captured. Recent damage events may include, for instance, hurricanes, storms, tornados, wildfires, floods, etc., and the recent damage event provided to the computer vision model include the type, severity, and time of the recent damage event. In these examples, the additional input data may enable the computer vision model to learn to associate visual features of damaged roofs with particular types (and severities) of roof damage events, thereby improving the accuracy of the model in determining causes of roof damage, determining repair cost estimates, performing fraud detection, etc.

In various examples, the computer vision model may be designed and trained to output various different types of damage assessment data. For example, the computer vision model could be trained to output a binary determination and/or a probability indicating the likelihood that the roof has sustained damage. Additionally or alternatively, the computer vision model may output an assessment of the severity of the damage and/or an estimated cost of the extent of any detected damage. In some examples, the computer vision model may be trained to predict specific causes of roof damage, such as distinguishing between wind damage, hail damage, fire damage, damage from falling debris, etc. Additionally, the computer vision model may output an estimated repair cost for any detected damage or may determine whether a complete roof replacement is likely to be required.

In various implementations, individual computer vision models may be trained to output any of the possible outputs described herein associated with roof damage assessments. For instance, entirely different models may be trained to perform damage detection, output a repair estimate, determine a cause, determine a fraud likelihood, etc. However, in other cases, a computer vision model may be implemented with a multilayer architecture including shared deep learning layers and multiple specialized output heads. For instance, because the various roof damage assessment outputs described herein may be related, a single foundation may be used having the same set of pre-trained deep learning layers. Then, on top of the pre-trained foundation model, the multilayer architecture may include different output heads each trained (e.g., fine-tuned) to perform a particular damage assessment task. For instance, a first output head may determine a damage probability, a first output head may determine a likely cause of the damage, a third output head may determine a cost estimate, a fourth output head may determine the likelihood of fraud (e.g., based on manufactured or intentional damage, etc.). In these examples, the multilayer and multi-head architecture may allow the computer vision model to simultaneously evaluate the roof for multiple damage types, and to provide comprehensive damage assessment results.

Further, in some examples, different variants of computer vision models can be generated and trained to assess damage associated with specific types of roof attributes, damage events, etc. For example, different model variants may be trained using separate repositories of training data having images of different roof types and/or materials (e.g., separately trained models for asphalt shingles, wood shakes, corrugated metal roofing, etc.), different damage events (e.g., separately trained models for hail damage, wind damage, fire damage, etc.), separately trained models for geographic regions having varying weather patterns, and the like.

In some examples, the computer vision model may be implemented using a recurrent neural network (RNN) architecture that may be trained to analyze a series of associated roof images. In such examples, rather than processing a single roof damage image, the RNN may be provided with a group or series of images captured of the same roof within the same time period. The RNN may use hidden layers and recurrent (e.g., self-looping) workflows to consider the entire image set when determining its outputs. For instance, based on training data including sets of multiple images of the same damaged roof, the RNN may learn to potentially predict the presence or absence of various types of damage in different images in the sets of images, based on the other images in the set. In some cases, the RNN may use long short-term memory (LSTM) networks to effectively remember and consider information from previous roof images in the series of images.

In these examples, an RNN-based implementation for the computer vision model may have particular advantages for detecting rare, inconsistent, and/or potentially fraudulent instances of roof damage. For instance, the RNN may be capable of analyzing unexpected disparities or inconsistencies between the different roof images in a set of input images, and/or between different portions of the roof across multiple images. Based on the presence of such disparities or inconsistencies, the RNN may potentially determine that the roof damage was likely manufactured (e.g., intentionally created) such as damage caused by a person stomping on a roof, or using a hammer or other tool to inflict the damage. Thus, implementations using an RNN and/or other ML technologies capable of analyzing interconnected inputs, such as transformer-based models, self-attention and cross-attention mechanisms, and the like, may enhance the ability of the damage assessment system to identify suspicious damage patterns that may warrant further investigation.

As described herein, the damage assessment system may use a combination of ML models, including a segmentation model used in the first stage of the system and a computer vision model used after the segmentation model. In some examples, the segmentation model may be a generalized pre-trained segmentation model, and need not be specifically trained on roof image data. Such examples provide a number of technical advantages, including avoiding the need for extensive segmentation training on specialized roof datasets, which can be time-consuming and resource-intensive to collect and label. Instead, the damage assessment system can leverage existing off-the-shelf segmentation models that are trained on large and diverse datasets of various objects. This approach may allow for more rapid deployment and adaptation of the segmentation portion of the damage assessment system, without requiring a lengthy segmentation model training phase focused specifically on roofs.

For training the computer vision model used in the second stage of the damage assessment system, a training system described herein may utilize a repository of labeled training data images depicting roof damage. These training images may include real-world and/or synthetically generated images representing various roof surfaces (e.g., different roof surface types, materials, colors, styles, pitches, etc.), various types and severities of roof damage (e.g., damage from wind, hail, fire, water, falling debris, as well as intentionally inflicted damage that may indicate fraud). Additionally, the training images may include roof damage images from various different image-capture techniques (e.g., handheld cameras, drones, etc.) and may include various image characteristics (e.g., various image ranges, resolutions, lighting conditions, including the presence of foreign objects, etc.).

Within a training data repository for the damage assessment system, the training images may be labeled (e.g., with image tags and/or metadata) indicating the ground truth damage information for the image. For instance, image tags/labels for training images may indicate the damage attributes (e.g., the type, cause, and/or severity of the damage), the roof attributes, potential fraud indicators, the cost of fixing the damage, whether the roof is considered to be totaled, etc. During the training process, the training system may perform segmentation on each training image using the segmentation model. Then, the training system may use supervised learning techniques to train the computer vision model based on the image data and segmentation data. For example, the training system may generate and provide a multichannel image representation to the computer vision model, and compare the damage assessments output by the computer vision model to the corresponding ground truth damage assessment labels associated with the image. During training, loss may be computed (e.g., using an L1 or L2 loss function) by comparing the predictions of the computer vision model to the ground truth damage assessments for the image, allowing the computer vision model to iteratively improve its damage assessment accuracy.

In some examples, because of the general scarcity of images that depict damaged roofs (e.g., due to the infrequency of roof damage events and the logistical difficulties in capturing images of damaged roofs), training the damage assessment system may include receiving and/or generating a large and diverse set of roof damage images. In some examples, one or more generative ML models may be used to generate a repository of synthetic roof damage images based on limited seed images, as described in more detail in U.S. patent application Ser. No.______, filed______, and titled “Generative Machine Learning Models For Generating Roof Damage Images,” which is incorporated by reference herein, in its entirety, for all purposes.

The techniques discussed herein can improve the functioning of computing systems and ML models in several ways. For instance, the combined use of segmentation models and computer vision models described herein may allow for more efficient and accurate processing and analysis of roof image data. By first applying a segmentation model to outline shapes and identify features on the roof surface, the system can provide richer and more structured input to the subsequent computer vision model. This two-stage approach enables the computer vision model to learn to identify and assess damage by analyzing pre-segmented regions of interest, potentially improving both the speed and accuracy of damage assessments compared to analyzing raw image data alone.

Further, the incorporation of segmentation data (e.g., a segmentation mask) into the input of the computer vision model may improve the accuracy of the system when analyzing partially obstructed and/or low-resolution images. This may be particularly beneficial for assessing damage images captured by drones or low-altitude plane flyovers in the aftermath of widespread weather events or natural disasters.

Additionally, examples that use multichannel image representations that incorporate image data, segmentation data, and/or additional roof attributes, may enable the computer vision models to learn from multiple modalities simultaneously. This multimodal approach may enhance the ability of the computer vision model to detect subtle patterns, relationships between the different data modalities, and/or anomalies associated with different types of roof damage. Thus, these implementations may lead to more robust damage detection, including the capability of the model to distinguish between various causes of damage (e.g., wind damage, hail damage, fire damage, etc.) and to detect potential manufactured damage caused by fraud. Furthermore, certain examples may implement an RNN within the computer vision model to analyze sets of multiple images of different portions of the same damaged roof. These examples may enable the damage assessment system to consider spatial patterns and changes in the assessed roof damage. This multi-image spatial analysis may improve the detection of rare, anomalous, or fraudulent roof damage events by identifying inconsistencies in damage patterns/characteristics on different portions of the same damaged roof.

Further, by reducing or eliminating the need for manual roof inspections, the techniques herein may significantly improve safety outcomes by minimizing the risks of physical roof access. Moreover, these techniques may provide the ability to rapidly analyze large numbers of images of potentially damaged roofs. The combined segmentation and computer vision models described herein may greatly enhance the efficiency of damage assessments performed in the insurance and construction industries, particularly in response to large-scale weather events and natural disasters. Such efficiency improvements may result in faster claims processing and more timely initiation of roof repairs, improving outcomes for property owners and insurers.

Moreover, the techniques described herein may enhance the ability to analyze roof damage more accurately. This may lead to a better understandings of damage risks, allowing for more precise insurance pricing and/or more accurate insurance rates. Existing computer vision models often struggle to distinguish between damaged and undamaged areas due to the lack of high contrast in the image data. In contrast, the advanced segmentation models described herein may effectively highlight shape anomalies, which then may enable the computer vision model to achieve higher accuracy.

Additionally, in some examples, the training of the segmentation models and/or computer vision models described herein may be improved by fine-tuning and/or manually adding segmentation masks to some training images. Such techniques may further enhance the quality of the segmentation, in contrast to previous techniques that would only adjust the computer vision model during training.

The techniques described herein can be implemented in a number of ways. Example implementations are provided with reference to the following FIGURES. Although discussed in the context of roof damage detection and assessment, the methods, apparatuses, and systems described herein can be applied to a variety of image-based inspection and damage assessment applications, and are not limited to roof surfaces. For example, the techniques can be utilized in other structural inspection contexts, such as assessing damage to building exteriors or interiors (e.g., floors, walls, driveways, etc.), land, bridges, dams, roads, or other infrastructure. Additionally, the techniques could be applied to perform damage inspections and assessments of vehicles, aircraft, ships, or industrial equipment.

Furthermore, while the examples primarily describe processing visual image data, the core approach of using a segmentation model followed by a specialized computer vision model could be adapted to analyze data from various types of sensors. For instance, the damage assessment system could be configured to process thermal imaging data, LiDAR point clouds, radar returns, and/or multispectral imagery. The segmentation and computer vision models described herein may be trained on these different data types, individually or in any combination, to identify patterns and anomalies indicative of damage or other conditions of interest.

### BRIEF DESCRIPTION OF THE DRAWINGS

The detailed description is set forth with reference to the accompanying FIGURES. In the FIGURES, the left-most digit(s) of a reference number identifies the figure in which the reference number first appears. The use of the same reference numbers in different FIGURES indicates similar or identical items or features.

FIG. 1 is an illustrated flow diagram depicting an example technique for performing a roof damage assessment using a combination of image segmentation and computer vision models, in accordance with one or more examples described herein.

FIG. 2 is a schematic diagram illustrating an example system including a segmentation model and a computer vision model trained to perform damage assessments, in accordance with one or more examples described herein.

FIGS. 3A and 3B depict two examples of image segmentation performed on a roof damage image, in accordance with one or more examples described herein.

FIG. 4 is a diagram illustrating an example system including a computer vision model trained to perform damage assessments comprising deep learning layers and multiple output heads, in accordance with one or more examples described herein.

FIG. 5 is a diagram illustrating an example training system for training a computer vision model to perform damage assessments, in accordance with one or more examples described herein.

FIG. 6 is a diagram illustrating an example system including a computer vision model including a recurrent neural network (RNN) trained to perform damage assessments, in accordance with one or more examples described herein.

FIG. 7 shows an example system architecture for a computing device capable of executing program components in implementing various techniques described herein.

### DETAILED DESCRIPTION

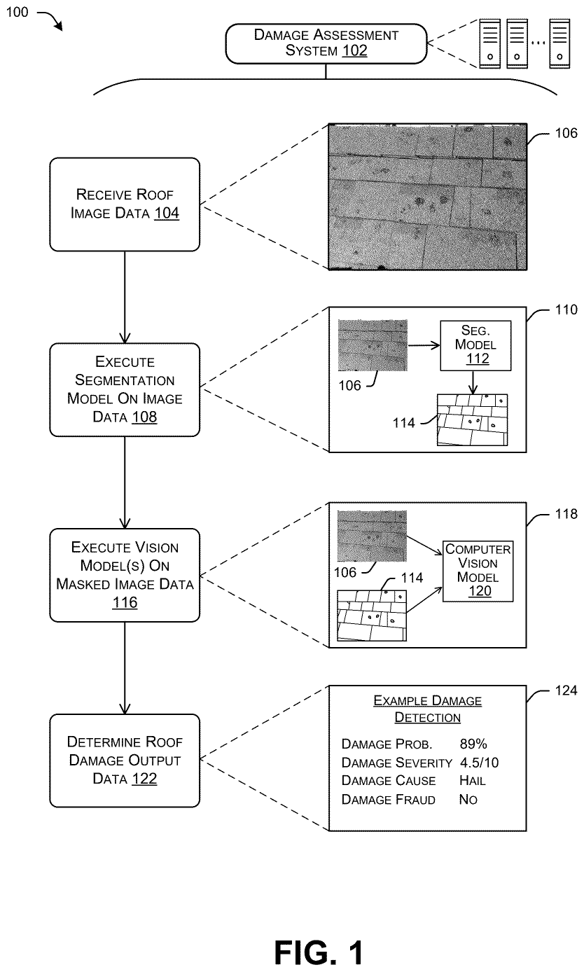

Referring to FIG. 1, a flow diagram 100 is shown depicting an example machine learning (ML) technique for performing a roof damage assessment based on image data of a damaged roof surface. As shown in this example, the damage assessment system 102 may use a combination of trained ML models, including a segmentation model and a computer vision model, to perform image-based inspection and assessment of damaged roofs.

At operation 104, the damage assessment system 102 may receive one or more images 106 of a roof surface. As described herein, the damage assessment system 102 may be trained to detect and/or assess various types of roof damage based on the input image 106. Although the input image 106 in this example depicts a damaged roof, in other examples, the input may include images of undamaged roofs as well. In some examples, the damage assessment system 102 may be configured to detect any type of roof damage. However, in other cases, the damage assessment system 102 may be specifically trained to detect only certain types of damage, such as recent damage and/or damage from specific damage events (and not others). In these more targeted implementations, older roofs exhibiting normal wear and tear, or roofs with damage from a previous damage event may be considered as undamaged with respect to the assessment performed by the damage assessment system 102.

As shown in this example, the input to the damage assessment system 102 may consist solely of image data. This could include a single image input 106 or multiple images of the same roof, with the damage assessment system 102 configured to perform the damage assessment based on the image data alone. However, in other examples, the damage assessment system 102 may be configured to receive additional types of input data beyond just images. For instance, the input data received in operation 104 also may include attributes of the roof surface depicted in the input image 106 (e.g., roof material, pitch, age, etc.), input information relating to recent damage events in the area (e.g., a hailstorm, hurricane, tornado, wildfire, etc.), or other relevant contextual data that may be used by the system to enhance its damage assessment capabilities.

At operation 108, the damage assessment system 102 may execute a segmentation model 112 based on the input image 106 received in operation 104, to determine segmentation data 114. In some examples, the segmentation model 112 may be a pre-trained generalized segmentation model that need not be specifically trained based on roof images. As noted above, in these examples, the damage assessment system 102 may leverage existing general-purpose segmentation models without requiring extensive training on specialized roof datasets.

As shown in box 110, the output of the segmentation model 112 may be segmentation data 114, which may include a segmented image and/or segmentation mask. A segmented image, for example, may be a monochromatic image having the same dimensions as the input image 106 and containing an outline that partitions the image into segments. Additionally or alternatively, the segmentation data 114 may include a segmentation mask. A segmentation mask may comprise a pixel-by-pixel representation (or may be partitioned into larger regions) having the same dimensions as the input image 106. The segmentation mask may store additional segment-related data for each pixel (or other region) of the image 106, based on the output of the segmentation model 112. In some cases, a segmentation mask may store an associated segment identifier for each pixel in the image 106. Additionally or alternatively, segmentation masks may store additional segment attributes for each pixel in the image 106, such as encoded data representing a segment shape, segment size, segment color, etc.

In some examples, operation 108 also may include executing one or more additional object detection ML models. Such object detection models may be specialized models (e.g., trained based on roof image segments) used to classify the various segments determined by the segmentation model 112. For instance, an object detection model may receive a single segment as input, and may be trained output a classification (or type) associated with the segment. The classification may be performed based on the size, shape, and color of the segment, etc. Examples of roof segment classifications may include roof elements such as a shingle, shake, or tile, or damage features such as a dent or crack, etc.

At operation 116, the damage assessment system 102 may execute one or more computer vision models 120 based on the image data and the segmentation data 114. As shown in box 118, the damage assessment system 102 may combine the image data 106 with a segmentation image or segmentation mask output by the segmentation model 112 and may provide the combined data to a computer vision model 120. In some examples, the damage assessment system 102 may generate a multichannel (and multimodal) image representation by applying a segmentation mask (e.g., an additional encoded data channel storing a segment identifier and/or other segment attributes) to the image 106. As noted above, the segmentation mask may correspond to the same dimensions and/or same resolution as the image 106 and may store any number of additional data channels including encoded data representing the segment and/or segment attributes associated with each pixel (or other region) in the image 106. The multichannel image representation then may be provided as input to the computer vision model 120 in operation 116.

In other examples, rather than constructing a multichannel image that applies segmentation data 114 into the image data 106, the computer vision model 120 may be trained to receive multimodal input as separate input vectors. For instance, the image 106 may be concatenated with a feature vector that represents the segmentation data 114, such as an encoded segmentation outline, or a listing of various segments with their corresponding segment attributes (e.g., sizes, shapes, locations, etc.). In such examples, the computer vision model 120 may be trained to receive the multimodal input data (e.g., an image 106 and associated segmentation data 114) at separate predetermined input sizes and locations of the input layer of the model.

As shown in this example, a single computer vision model 120 may be trained to inspect and assess various types of roof damage images. However, in some examples, the damage assessment system 102 may include multiple computer vision models 120 and may select one or more of the computer vision model(s) for execution in operation 116, based on the roof material type, damage type, and/or other factors.

At operation 122, the damage assessment system 102 may determine and output roof damage assessment data 124 based on the output of the computer vision model 120. As noted above, computer vision model(s) 120 may be trained to output different types of damage assessment data 124. In this example, the computer vision model(s) 120 may be trained to output a probability that the image data 106 depicts a damaged roof (e.g., 89%), a severity of the damaged roof (e.g., 4.5 out of 10), a likely cause of the damage (e.g., hail), and an indication of the whether the roof damage was likely manufactured (e.g., intentional/fraudulent damage).

In some examples, a single computer vision model 120 may be trained to output any number of different damage assessment data, individually or in any combination. In some cases, the computer vision model 120 may include multiple fine-tuned output heads, each of which may be trained to determine different damage assessment data. For instance, the computer vision model 120 may include separate output heads for determining a damage probability, a damage severity, a damage cause, and a likelihood of fraud. As described below in more detail, a multi-head architecture for the computer vision model 120 may allow the model to simultaneously or alternatively evaluate the roof images for different aspects of damage and provide comprehensive assessment results, while also providing improved accuracy of the assessment for the individual tasks performed by each fine-tuned output head.

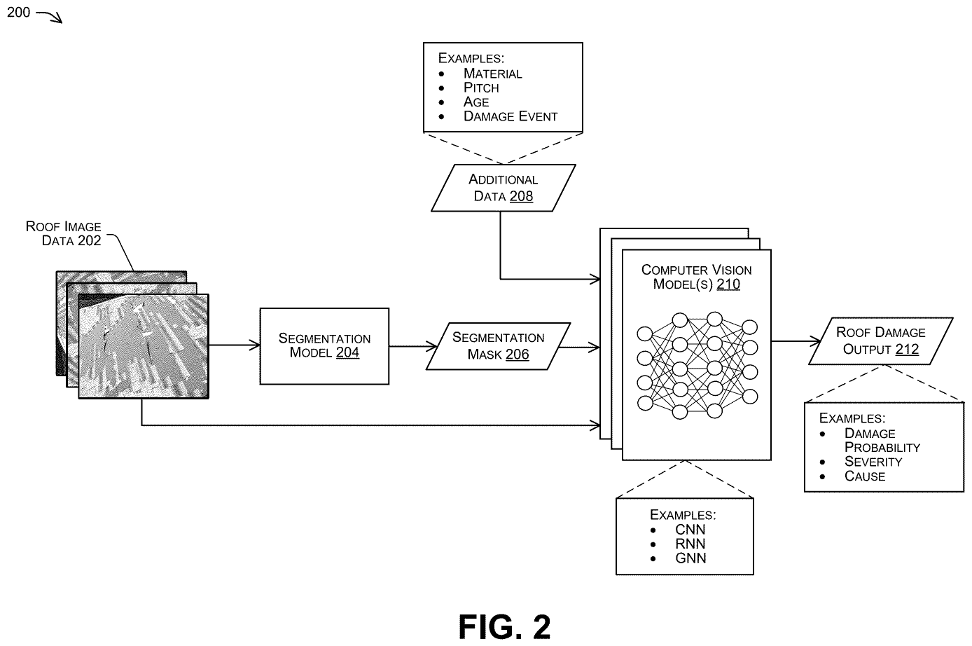

Referring to FIG. 2, an example architecture diagram is shown of a system 200 for performing damage assessments based on image data of damaged roof surfaces. In some examples, the system 200 may correspond to the damage assessment system 102 discussed above in FIG. 1. As shown in this example, the system 200 may include several interconnected components configured to work together to receive and process image inputs, using a combination of segmentation ML models and computer vision ML models to analyze and assess potential roof damage depicted within the input images.

As shown in this example, the system 200 (e.g., a damage assessment system 102) may be configured to receive roof image data 202 as input. The roof image data 202 may comprise a single image of a damaged (or undamaged) roof surface, or may comprise multiple related images (e.g., images of the same roof surface). The image(s) within the roof image data 202 may be input into a segmentation model 204 trained to output a segmentation mask 206. In some examples, the segmentation model 204 may be implemented as a Segment Anything Model (SAM) or other general-purpose segmentation machine learning model trained to recognize and segment various shapes and features present in the roof image data 202. The output of the segmentation model 204 may include a segmentation mask 206 which defines the various distinct segments identified by the model within the roof image.

The system 200 only includes one or more computer vision model(s) 210, which may be trained to analyze and assess roof damage based on the multimodal inputs (e.g., the roof image data 202 and segmentation mask 206). The computer vision model(s) 210 may be implemented using various types of neural network architectures, such as convolutional neural networks (CNNs), recurrent neural networks (RNNs), or graph neural networks (GNNs), etc. As described herein, the computer vision model(s) 210 may be trained to recognize, classify, and assess roof damage. In various examples, the computer vision model(s) 210 may be trained using training data including combinations of training images of damaged roofs along with corresponding segmentation data. The computer vision model(s) 210 may be trained with large and diverse sets of training images, and thus may be able to accurately detect and assess roof damage depicted in images of various different types of roofs (e.g., different roof materials, styles, pitches, ages, etc.) and various different types of damage (e.g., hail damage, wind damage, fire damage, etc.). Additionally, the computer vision model(s) 210 may be trained using training images having different image characteristics (e.g., image ranges, resolutions, angles, lighting conditions, etc.), and thus may be able to accurately detect and assess roof damage from images having these various different image characteristics.

In some examples, the system 200 may incorporate various additional data 208 into the automated roof damage assessment. As shown in this example, the additional data 208 may include information such as the roof material type, pitch, age, and/or details associated with a recent damage event that may have affected the roof. In these examples, the additional data 208 may be used to enhance the accuracy of the damage detection process by providing contextual information about the roof to the computer vision model(s) 210. The additional data 208 may be provided concurrently with the roof image data 202, and/or may be retrieved from one or more different data sources. For instance, after providing one or more roof images as input, the system 200 may query a user (e.g., via a graphical user interface) for additional information about the roof depicted in the input images. In other cases, the system 200 may retrieve additional information about the roof (e.g., based on an address or location provided with the roof images) from one or more backend servers or services based on the address/location data.

As shown in this example, the additional data 208 may be provided as a supplemental input to the computer vision model(s) 210, along with the roof image data 202 and the segmentation mask 206. In some instances, the additional data 208 may be encoded into the segmentation mask 206 and/or may be included in a multichannel representation of the roof image. In these instances, the additional roof attributes (e.g., roof pitch, material, age, etc.) may be determined for each pixel or region in the roof image data 202, and the roof attributes may be encoded as additional data channels in the multichannel representation. As noted above, these implementations may provide particular advantages when the roof image data 202 depicts a non-uniform roof surface (e.g., roof surfaces having different portions with different pitches, different materials, different ages, etc.).

In other examples, the additional data 208 may be used by the system 200 in different ways. For instance, the additional data 208 may be encoded into a feature vector and provided as a separate input to the computer vision model 210 (e.g., concatenated with the roof image data 202 and the segmentation mask 206). In still other examples, the system 200 may include multiple computer vision models 210 trained based on different roof material types, different roof pitches, different types of damage events, etc. In these examples, the system 200 may analyze the additional data 208 during inference and select one of the computer vision models 210 to execute based on the additional data 208, providing as input to the selected computer vision model 210 the roof image data 202 and segmentation mask 206.

The use of the additional data 208 may be optional and need not be used in some cases. In examples when the system is configured to determine and provide additional data 208 to the computer vision model 210, the computer vision model 210 thus may comprise a multimodal ML model that receives input data including a combination of roof image data and associated additional data 208. In such cases, the computer vision model(s) 210 also may be trained using corresponding multimodal training data, such as inputs comprising training images and separate text data (or other inputs) representing additional data 208 associated with the inputs. In some cases, such multimodal inputs may be provided as separate vectors provided to different input layers of the computer vision model(s) 210. Additionally or alternatively, the computer vision model(s) 210 may be trained as multimodal ML models based on multichannel representations of roof damage images (e.g., image data with additional encoded data channels).

Based on the output of the computer vision model(s) 210, the system 200 may determine a roof damage output 212 indicating the inspection results and/or damage assessment associated with the roof image data 202. In various examples, the computer vision model(s) 210 may be trained to output various types of roof damage output 212, including information such as a binary damage determination, damage probability, the severity of the damage, the cause of the damage, and/or confidence levels associated with any of the outputs. In some examples, the roof damage output 212 also may include a determination and/or likelihood that the damage depicted in the roof image data 202 was manufactured (e.g., human-caused) and/or fraudulent.

In some examples, the system 200 may be implemented in one or more computing devices or servers equipped with the necessary hardware and software components to execute the segmentation model 204 and the computer vision model(s) 210. The system 200 may also be connected to a network and may include one or more interfaces (e.g., graphical user interfaces, command line interfaces, application programming interface (APIs), etc.) for receiving the roof image data 202 and the additional data 208, and for transmitting the roof damage output 212 to a user device and/or other external system. In some instances, the system 200 also may be part of a larger system or platform for processing and analyzing roof damage claims. For example, the system 200 may be integrated with a claims management system of an insurance provider, a customer service platform, or a drone-based roof inspection system. The system 200 may also be used in conjunction with other data analysis techniques and/or systems to further enhance the accuracy and efficiency of roof inspection and damage assessment processes.

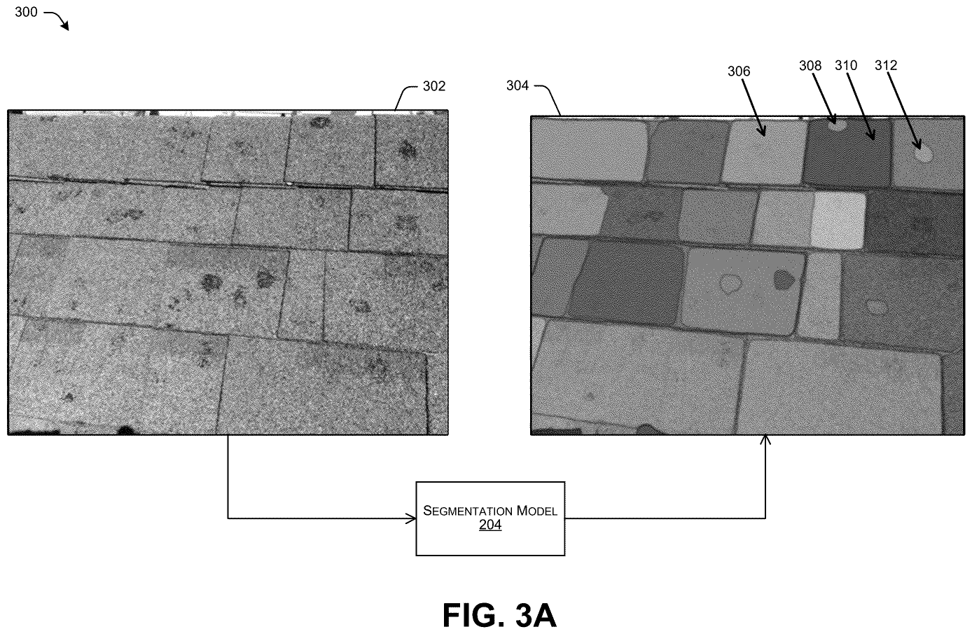

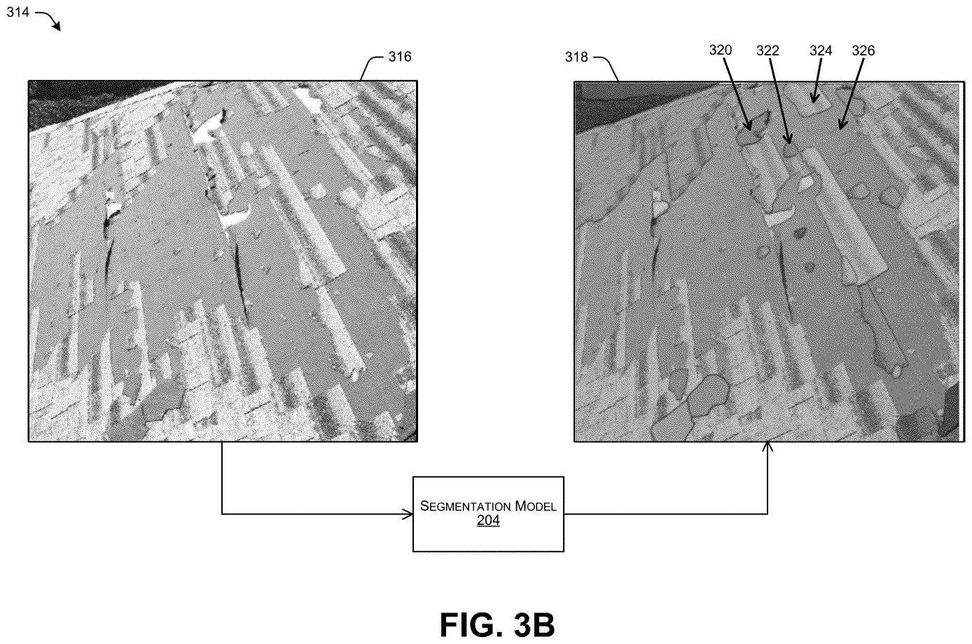

Referring to FIGS. 3A and 3B, two examples are shown of image segmentation processes performed on images of roof damage. As noted above the segmentation model 204 may be implemented as a Segment Anything Model (SAM), or other general-purpose segmentation ML model. Thus, the segmentation model 204 need not be trained specifically on roof image data (although it could be) but may nonetheless effectively segment the images of roof surfaces without recognizing or understanding the meaning of the various segments.

FIG. 3A shows a first example 300 of a roof image 302 depicting hail damage to an asphalt shingle roof. In this example, the segmentation model 204 may receive the roof image 302 as input and may output the segmentation mask 304. As shown in this example, the segmentation model 204 has identified a number of distinct shapes (or “segments”) in the roof image 302 and has encoded these segments in the segmentation mask 304. In various examples, the segmentation model 204 also may determine additional segment attributes, such as segment size, shape, and color, etc., and may encode those segment attributes into the segmentation mask 304 as well.

The segmentation model 204 may be configured to associate every pixel in the roof image 302 with exactly one segment. Thus, the segmentation mask may include per-pixel data identifying, for every pixel in the roof image 302, the segment encompassing that pixel. For illustrative purposes, only four segments 306-312 are identified in this example: a first segment 306 representing an undamaged shingle, a second segment 308 representing a hail damage mark (or dent), a third segment 310 representing a damaged shingle, and a fourth segment 312 representing another hail damage mark (or dent). As noted above, the segmentation model 204 may use ML image analysis techniques to effectively identify these segments, even within low-resolution roof images, without the need to classify or understand the meaning of the various segments.

FIG. 3B shows a second example 314 of a roof image 316 depicting severe wind damage to an asphalt shingle roof. As in the previous example, the segmentation model 204 may receive the roof image 316 as input and may output the segmentation mask 318. In this example, the segmentation model 204 has identified a number of distinct shapes in the wind-damaged roof and has encoded these as segments in the segmentation mask 318. The segmentation model 204 also may, in some examples, determine and encode additional segment attributes such as size, shape, color, etc., into the segmentation mask 304. For illustrative purposes, only four segments 320-326 are identified in this example: each representing a damage pattern caused by the wind damage. As noted above, the segmentation model 204 may use ML image analysis techniques to effectively identify segments 320-326 as distinct shapes within the roof image 316, without classifying or understanding the meaning of these segments.

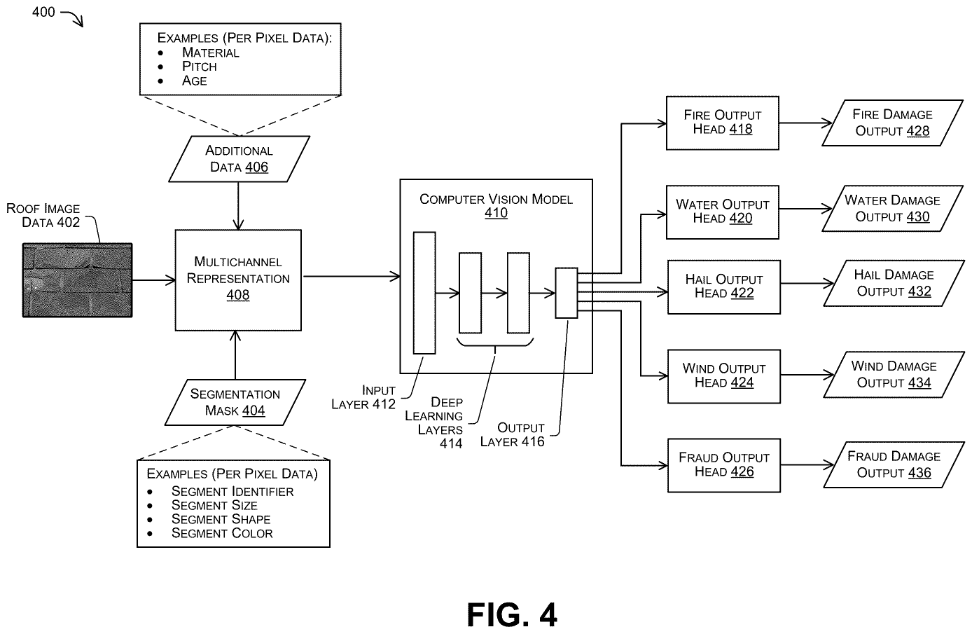

Referring to FIG. 4, another example architecture diagram is shown of a system 400 for performing damage assessments based on image data of damaged roof surfaces. In some examples, the system 400 may correspond to the damage assessment system 102 discussed above in FIG. 1. The system 400 may include several interconnected components, described below in more detail, configured to work together to receive and process image inputs, using a combination of segmentation ML models and computer vision ML models (with multiple output heads) to analyze and assess potential roof damage depicted within the input images.

As shown in this example, the system 400 (e.g., a damage assessment system 102) may receive roof image data 402 as input. The roof image data 402 may be input into a segmentation model (not shown) trained to output a segmentation mask 404. As described above, the segmentation model used in this example may be a general-purpose segmentation model or may be trained specifically based on roof images. In either case, the segmentation model may effectively recognize and segment the image based on shapes detected in the roof image data 402. The output of the segmentation model may include a segmentation mask 404, which may have the same width and length dimensions as the roof image data 402 and may identify the distinct shapes as segments within the roof image data 402. The segmentation mask 404 may store only a segment identifier in some examples, while in other examples segmentation mask 404 may store additional segment attributes (e.g., segment size, shape, color, depth, object type, etc.).

In some cases, the system 400 also may receive additional data 406 associated with the roof depicted in the roof image data 402. For instance, the additional data 406 may include the roof material, roof pitch, roof age, and/or other data which may or may not be discernable from the roof image data 402 itself. As noted above, the additional data 406 may be received via one or more interfaces, or may be retrieved based on metadata or other data associated with the roof image data 402 (e.g., an address or location of the building). Along with the segmentation data (e.g., segmentation mask 404), the additional data 406 may be used to enhance the accuracy of the damage detection process by providing segment information and additional contextual information about the roof to the computer vision model 410.

As shown in this example, the system 400 may generate a multichannel representation 408 to store the combination of the multimodal image data, segmentation data, and additional data. In some instances, the segmentation mask 404 and/or additional data 406 may be applied to the raw roof image data 402 as supplemental data channels associated with each pixel (or other region) in the in the roof image data 402. For example, the supplemental data channels (or data layers) added to the roof image data 402 to construct the multichannel representation 408 may include one or more additional layers to store the various segmentation data within the segmentation mask 404, and/or additional layers to store any additional data 406.

The multichannel representation 408 may be provided as input to the computer vision model 410, which may correspond to any of the computer vision model(s) 210 discussed above. In this example, the computer vision model 410 may be trained based on similar multichannel representations that include raw image data, segmentation data, and additional data. Thus, during training, the computer vision model 410 may learn the relevance of these supplemental data layers in relation to the image data, thereby allowing the computer vision model 410 to perform more nuanced and accurate damage detection and assessments.

The computer vision model 410 in this example may consist of an input layer 412, followed by any number of deep learning layers 414, and an output layer 416. The deep learning layers 414 may be trained to process the multichannel input data in order to extract relevant features for performing different types of damage detections. As shown in this example, the output layer 416 of the computer vision model 410 may be connected to multiple output heads associated with different types (e.g., different potential causes) of roof damage. In this example, the computer vision model 410 may include an associated fire output head 418, a water output head 420, a hail output head 422, a wind output head 424, and a fraud output head 426. Each of these output heads may produce a corresponding damage output. For example, the fire output head 418 may produce a fire damage output 428, the water output head 420 may produce a water damage output 430, the hail output head 422 may produce a hail damage output 432, the wind output head 424 may produce a wind damage output 434, and the fraud output head 426 may produce a fraud damage output 436.

The architecture depicted in this example may allow the system 400 to simultaneously and/or alternatively assess multiple possible types of roof damage. The various output heads may be fine-tuned separately using training data of roof damage images having the same damage type as the associated output head. This may allow each of the output heads to learn to more accurately analyze and assess their own particular type of damage, thereby providing more accurate damage assessments. In some examples, when the type/cause of the roof damage of known in advance, only the corresponding output head may be executed to more accurately assess the damage. In other cases, multiple (or all) of the output heads may be executed to determine the most likely potential causes of the damage.

In some examples, the system 400 may be implemented in one or more computing devices or servers equipped with the necessary hardware and software components to generate the multichannel representation 408, segment the image data, and execute the computer vision model 410 and the various output heads. The system 400 may also be connected to a network and may include one or more interfaces (e.g., graphical user interfaces, command line interfaces, application programming interface (APIs), etc.) for receiving the roof image data 402 and the additional data 406, and for transmitting the various damage outputs to a user device and/or other external system. In some instances, the system 400 also may be part of a larger system or platform for processing and analyzing roof damage. For example, the system 400 may be integrated with a claims management system of an insurance provider, a customer service platform, or a drone-based roof inspection system. The system 400 may also be used in conjunction with other data analysis techniques and/or systems to further enhance the accuracy and efficiency of roof inspection and damage assessment processes.

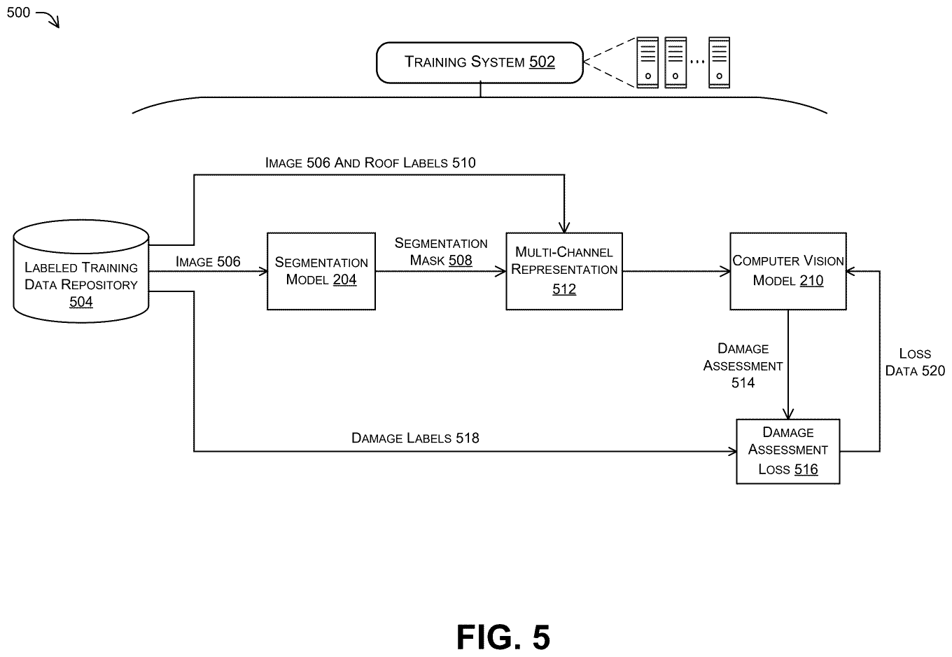

Referring to FIG. 5, a diagram 500 is shown illustrating an example training system 502 for training a computer vision model 210 for use in a damage assessment system 102. In this example, the training system 502 includes a labeled training data repository 504 that stores various training images of damaged roofs and corresponding ground truth damage labels. In some cases, additional data (e.g., roof attributes such as roof material, pitch, age, etc.) may be stored as roof labels associated with the images in the labeled training data repository 504 and may be used to train the computer vision model 210.

As shown in this example, training a computer vision model 210 may generally comprise performing a series of training operations on ground truth roof damage images in the labeled training data repository 504. During a training operation, the training system 502 provides an image 506 from the labeled training data repository 504 to the segmentation model 204. The segmentation model 204 processes the image 506 to produce a segmentation mask 508. The training system 502, using the techniques described herein, may generate a multichannel representation 512 based on the image 506, the segmentation mask 508, and/or (optional) roof labels 510 including various additional roof attributes. The multichannel representation 512 may be provided as input to the computer vision model 210, which may output a damage assessment 514 corresponding to a damage prediction associated with the image 506.

The training system 502 may use a damage assessment loss component 516 to compute loss data 520 (e.g., using L1 or L2 loss functions) based on comparing the damage assessment 514 output by the computer vision model 210, to the ground truth damage labels 518. In various examples, the damage assessment 514 and the ground truth damage labels 518 may include any of the damage output data described herein, such as damage determinations, severities, causes, and/or probabilities/confidence levels associated with any of the outputs. The loss data 520 may be a quantifiable (e.g., numeric) value representing how effectively and accurately the computer vision model 210 assesses the roof damage in the image 506. The computer vision model 210 may be trained based on the loss data 520 from any number of training operations performed on any number of images 506.

In some cases, the training system 502 may use similar or identical techniques for fine-tuning any output heads associated with the computer vision model 210, such as different output heads associated with different damage types/causes, or different output heads associated with different roof material types, etc. For training the computer vision model 210 and/or the various output heads, the training process may involve multiple iterations of processing the training data from the labeled training data repository 504, adjusting the network layers of the computer vision model 210 based on the loss data 520, and reprocessing the training data. This iterative process may allow the computer vision model 210 to learn from its mistakes and gradually improve its performance. The training process may continue until the computer vision model 210 reaches a desired level of accuracy in damage assessment, or until a predetermined number of training iterations have been completed.

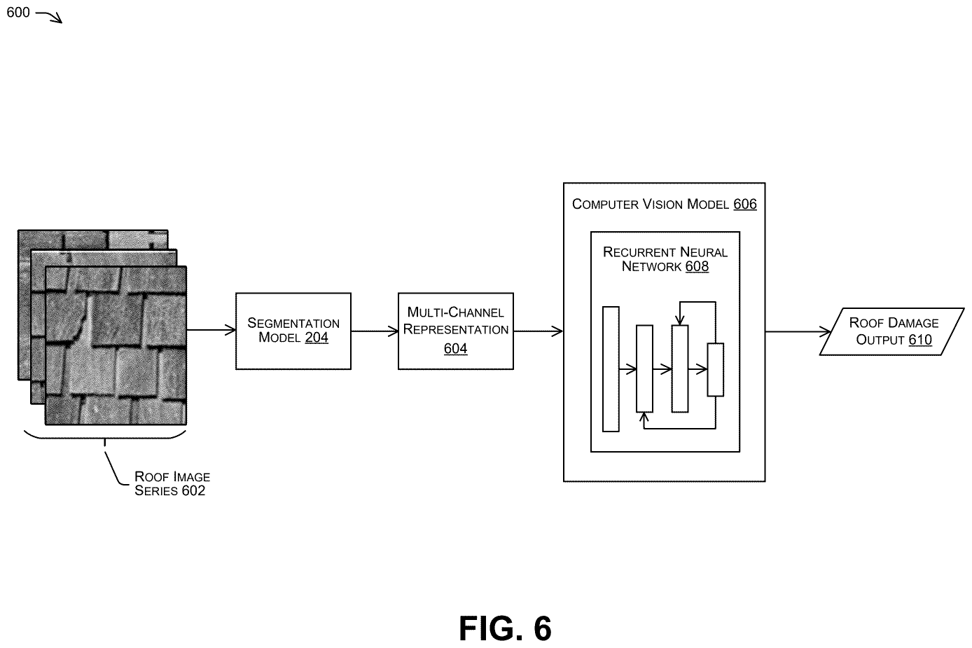

Referring to FIG. 6, another example architecture diagram is shown of a system 600 for performing damage assessments based on image data of damaged roof surfaces. As shown in this example, the system 600 may correspond to the damage assessment system 102 discussed above in FIG. 1. The system 600 may include several interconnected components, described below in more detail, configured to work together to receive and process sets (or series) of images, using a combination of a segmentation ML model and a computer vision ML model using a recurrent neural network to analyze and assess potential roof damage depicted within the series of input images.

Similar to system 200 and system 400 in the previous examples, system 600 (e.g., a damage assessment system 102) may receive roof image data as input. In this example, the roof image data may include a series of images captured of the same damaged roof within the same general time period. The system 600 may process the images individually using a segmentation model 204 and may generate a multichannel representation 604 based on the output of the segmentation model 204. As described herein, the multichannel representation 604 may be a multimodal representation constructed based on any combination of the raw image data, the segmentation data (e.g., a segmentation mask) applied to the raw image data, and/or additional data such as roof attributes, damage events, etc.

The multichannel representation 604 may be provided as input to the computer vision model 606, which may correspond to any of the computer vision model(s) 210 discussed above. In this example, the computer vision model 606 may be implemented using a recurrent neural network (RNN) 608 trained based on multichannel representations similar to the multichannel representation 604. In contrast to certain other types of computer vision models, the RNN 608 may use hidden layers and recurrent (e.g., self-looping) workflows so that it learns based on complete image sets during training and considers the entire roof image series 602 when determining its roof damage outputs 610. Thus, the RNN 608 within the computer vision model 606 may be trained to analyze sets of multiple images of different portions of the same damaged roof. For instance, based on the roof image series 602 comprising multiple images of the same damaged roof, the RNN 608 may potentially predict the presence or absence of various types of damage in different images in the roof image series 602, based on the other images in the series. Thus, implementations such as system 600, in which an RNN 608 is used as the network for the computer vision model 606, may enable the system 600 to consider spatial patterns and changes when assessing roof damage based on the series of roof images. This multi-image spatial analysis may improve the accuracy of the roof damage outputs 610, especially in the detection of rare, anomalous, or fraudulent roof damage events, by identifying inconsistencies in damage patterns/characteristics on different portions of the same damaged roof.

In some examples, the system 600 may be implemented in one or more computing devices or servers equipped with the necessary hardware and software components to segment the image data, generate the multichannel representation 604, and execute the computer vision model 606 and RNN 608. The system 600 may also be connected to a network and may include one or more interfaces (e.g., graphical user interfaces, command line interfaces, application programming interface (APIs), etc.) for receiving the roof image series 602, and for transmitting the roof damage output 610 to a user device and/or other external system. In some instances, the system 600 also may be part of a larger system or platform for processing and analyzing roof damage. For example, the system 600 may be integrated with a claims management system of an insurance provider, a customer service platform, or a drone-based roof inspection system. The system 600 may also be used in conjunction with other data analysis techniques and/or systems to further enhance the accuracy and efficiency of roof inspection and damage assessment processes.

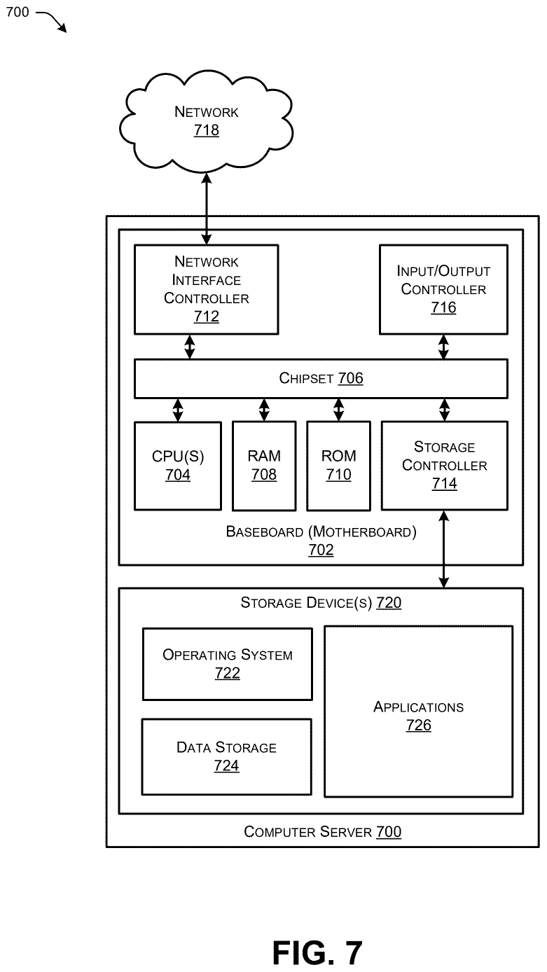

FIG. 7 shows an example computer architecture for a computer server 700 capable of executing program components for implementing the functionality described herein. The computer architecture shown in FIG. 7 may correspond to the systems and components of a server computer, workstation, desktop computer, laptop, tablet, network appliance, mobile device (e.g., tablet computer, smartphone, etc.), or other computing device, and can execute any of the software components described herein. For example, one or more computer servers 700 may correspond to and/or may be used to implement the various systems or devices described above, such as the damage assessment system 102, system 200, and/or various other systems including segmentation model(s) 204, computer vision model(s) 210, and/or any other components described herein. It will be appreciated that in various examples described herein, a computer server 700 might not include all of the components shown in FIG. 7, can include additional components that are not explicitly shown in FIG. 7, and/or may utilize a different architecture from that shown in FIG. 7.

The computer server 700 includes a baseboard 702, or “motherboard,” which may be a printed circuit board to which a multitude of components or devices are connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer server 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer server 700. The chipset 706 can further provide an interface to a computer-readable storage medium such as a ROM 710 or non-volatile RAM (“NVRAM”) for storing basic routines that help to startup the computer server 700 and to transfer information between the various components and devices. The ROM 710 or NVRAM can also store other software components necessary for the operation of the computer server 700 in accordance with the configurations described herein.

The computer server 700 can operate in a networked environment using logical connections to remote computing devices and computer systems through a network, such as the network 718, which may be similar or identical to the various communication links and/or network(s) discussed above. The chipset 706 also may include functionality for providing network connectivity through a Network Interface Controller (NIC) 712, such as a gigabit Ethernet adapter. The NIC 712 is capable of connecting the computer server 700 to other computing devices over the network 718. It should be appreciated that multiple NICs 712 can be present in the computer server 700, connecting the computer to other types of networks and remote computer systems. In some instances, the NICs 712 may include at least on ingress port and/or at least one egress port.

The computer server 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device.

The computer server 700 can include one or more storage device(s) 720, which may be connected to and/or integrated within the computer server 700, that provide non-volatile storage for the computer server 700. The storage device(s) 720 can store an operating system 722, data storage systems 724, and/or applications 726, which are described in more detail herein. The storage device(s) 720 can be connected to the computer server 700 through a storage controller 714 connected to the chipset 706. The storage device(s) 720 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer server 700 can store data on the storage device(s) 720 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device(s) 720 are characterized as primary or secondary storage, and the like.

For example, the computer server 700 can store information to the storage device(s) 720 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer server 700 can further read information from the storage device(s) 720 by detecting the physical states or characteristics of one or more particular locations within the physical storage units.

In addition to the storage device(s) 720 described above, the computer server 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer server 700. In some examples, the various operations performed by a computing system (e.g., damage assessment system 102, training system 502, etc.) may be supported by one or more devices similar to computer server 700. Stated otherwise, some or all of the operations described herein may be performed by one or more computers server 700 operating in a networked (e.g., client-server or cloud-based) arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device(s) 720 can store an operating system 722 utilized to control the operation of the computer server 700. In some examples, the operating system 722 comprises a LINUX operating system. In other examples, the operating system 722 comprises a WINDOWS® SERVER operating system from MICROSOFT Corporation of Redmond, Washington. In further examples, the operating system 722 can comprise a UNIX operating system or one of its variants. It should be appreciated that other operating systems can also be utilized. The storage device(s) 720 can store other system or application programs and data utilized by the computer server 700.

In various examples, the storage device(s) 720 or other computer-readable storage media is encoded with computer-executable instructions which, when loaded into the computer server 700, transform the computer from a general-purpose computing system into a special-purpose computer capable of implementing various techniques described herein. These computer-executable instructions transform the computer server 700 by specifying how the CPUs 704 transition between states, as described above. In some examples, the computer server 700 may have access to computer-readable storage media storing computer-executable instructions which, when executed by the computer server 700, perform the various techniques described herein. The computer server 700 can also include computer-readable storage media having instructions stored thereupon for performing any of the other computer-implemented operations described herein.

As illustrated in FIG. 7, the storage device(s) 720 may store one or more data storage systems 724 configured to store data structures and other data objects. Additionally, the software applications 726 stored on the computer server 700 may include one or more client applications, services, and/or other software components. For example, application(s) 726 may include any combination of the components 202-212 in a system 200 for performing image-based inspection and damage assessments, and/or any combination of the software components described above in reference to FIGS. 1-6.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.”

As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A method for machine learning detection of roof damage, the method comprising:
receiving image data representing a roof surface;
providing the image data as input to a first segmentation machine learning model;
determining a segmentation mask based on an output of the first segmentation machine learning model;
modifying the image data, into a modified image representation, based on the segmentation mask;
providing the modified image representation as input to a second computer vision machine learning model; and
performing a roof damage determination based on a second output of the second computer vision machine learning model.

2. The method of claim 1, wherein the second computer vision machine learning model is a recurrent neural network (RNN), and
wherein the method further comprises providing a plurality of modified image representations associated with the roof surface to the recurrent neural network.

3. The method of claim 1, wherein the segmentation mask includes one or more additional data channels associated with the image data, the additional data channels comprising at least one of:
a segment identifier label;
a segment shape label; or
a segment color label.

4. The method of claim 1, wherein the second computer vision machine learning model is trained to output a damage cause associated with damage to the roof surface, wherein the damage cause comprises at least one of:
wind damage;
hail damage; or
manufactured damage.

5. The method of claim 1, further comprising:
determining, using a third object detection machine learning model, a first object type associated with a first segment in the roof surface, wherein the segmentation mask includes the first object type.

6. The method of claim 1, wherein the first segmentation machine learning model is general segmentation model trained on non-roof image data.

7. The method of claim 1, further comprising:
determining a pitch associated with the roof surface; and
determining a material type associated with the roof surface,
wherein performing the roof damage determination is further based on the pitch and the material type.

8. The method of claim 7, wherein providing the modified image representation as the input to the second computer vision machine learning model comprises:
determining a fine-turned computer vision model, from a plurality of fine-turned computer vision models, based on the pitch and the material type.

9. The method of claim 1, wherein the second computer vision machine learning model is configured to output at least one of:
a probability that the roof surface includes damage;
a cause of the damage to the roof surface;
a probability that the damage to the roof surface exceeds a threshold; or
a probability that the damage to the roof surface is manufactured.

10. A machine learning roof detection system comprising:
one or more processors; and
memory storing computer-executable instructions that, when executed by the one or more processors, cause the system to perform operations comprising:
receiving image data representing a roof surface;
providing a first input based on the image data to a first segmentation model;
determining, based on a first output of the first segmentation model, a segmentation mask associated with the roof surface;
providing a second input, based on the image data and the segmentation mask, to a second computer vision model; and
determining a roof damage prediction, based on a second output of the second computer vision model.

11. The machine learning roof detection system of claim 10, wherein the second computer vision model is a recurrent neural network (RNN), and
wherein the operations further comprise providing a plurality of modified image representations associated with the roof surface to the recurrent neural network.

12. The machine learning roof detection system of claim 10, wherein the segmentation mask includes one or more additional data channels associated with the image data, the additional data channels comprising at least one of:
a segment identifier label;
a segment shape label; or
a segment color label.

13. The machine learning roof detection system of claim 10, wherein the second computer vision model is trained to output a damage cause associated with damage to the roof surface, wherein the damage cause comprises at least one of:
wind damage;
hail damage; or
manufactured damage.

14. The machine learning roof detection system of claim 10, the operations further comprising:
determining, using a third object detection model, a first object type associated with a first segment in the roof surface, wherein the segmentation mask includes the first object type.

15. The machine learning roof detection system of claim 10, wherein the first segmentation model is general segmentation model trained on non-roof image data.

16. The machine learning roof detection system of claim 10, the operations further comprising:
determining a pitch associated with the roof surface; and
determining a material type associated with the roof surface,
wherein determining the roof damage prediction is further based on the pitch and the material type.

17. The machine learning roof detection system of claim 16, the operations further comprising:
determining the second computer vision model from a plurality of fine-tuned computer vision models, based on the pitch and the material type.

18. One or more non-transitory computer-readable media storing instructions executable by a processor, wherein the instructions, when executed by the processor, cause the processor to perform operations comprising:
receiving image data representing a roof surface;
providing the image data as input to a first segmentation model;
determining a segmentation mask based on an output of the first segmentation model;
modifying the image data, into a modified image representation, based on the segmentation mask;
providing the modified image representation as input to a second computer vision model; and
performing a roof damage determination based on a second output of the second computer vision model.

19. The one or more non-transitory computer-readable media of claim 18, wherein the second computer vision model is a recurrent neural network (RNN), and
wherein the operations further comprise providing a plurality of modified image representations associated with the roof surface to the recurrent neural network.

20. The one or more non-transitory computer-readable media of claim 18, wherein the segmentation mask includes one or more additional data channels associated with the image data, the additional data channels comprising at least one of:
a segment identifier label;
a segment shape label; or
a segment color label.
